(19) United States
(12) Patent Application Publication
(10) Pub. No.: US 2011/0267319 A1
(43) Pub. Date: Nov. 3, 2011

(54) PIXEL AND ORGANIC LIGHT EMITTING DISPLAY USING THE SAME

(76) Inventor: Sam-Il Han, Yongin-city (KR)

(21) Appl. No.: 12/917,258

(22) Filed: Nov. 1, 2010

(30) Foreign Application Priority Data
May 3, 2010 (KR) 10-2010-0041390

(51) Int. Cl. G09G 3/32; G09G 5/00

(52) U.S. Cl. 345/204; 345/80

(57) ABSTRACT

A pixel includes an OLED configured to receive a pixel current that flows from a first pixel power source to a second pixel power source and to emit light, a first transistor having a first electrode coupled to a first node, a second electrode coupled to a second node, and a gate coupled to a third node, the first transistor being configured to control the pixel current, a second transistor for selectively supplying a data signal and an initialization signal to the first node, a third transistor for selectively coupling the second node to the third node, a fourth transistor having a second electrode and a gate coupled to the first node and a first electrode coupled to the third node, and a first capacitor having a first electrode coupled to the first pixel power source and a second electrode coupled to the third node.

### CROSS-REFERENCE TO RELATED APPLICATION

This application claims priority to and the benefit of Korean Patent Application No. 10-2010-0041390, filed on May 3, 2010, in the Korean Intellectual Property Office, the entire content of which is incorporated herein by reference.

### BACKGROUND

1. Field

An embodiment of the present invention relates to a pixel and an organic light emitting display using the same, and more particularly, to a pixel capable of reducing or preventing picture quality deterioration due to a difference in the threshold voltages of transistors and an organic light emitting display using the same.

2. Description of the Related Art

Recently, various types of flat panel displays (FPDs) capable of reducing weight and volume that are disadvantages of cathode ray tubes (CRTs) have been developed. The types of FPDs include a liquid crystal display (LCD), a field emission display (FED), a plasma display panel (PDP), and an organic light emitting display.

Among the FPDs, the organic light emitting display displays an image using organic light emitting diodes (OLEDs) that generate light by re-combination of electrons and holes.

The organic light emitting display is widespread in the market and can be found in devices such as personal digital assistants (PDAs), MP3 players, and mobile telephones and provide various features such as excellent color reproducibility and small thickness.

An OLED used for the organic light emitting display includes an anode electrode, a cathode electrode, and a light emitting layer formed between the anode electrode and the cathode electrode. In the OLED, when current flows from the anode electrode to the cathode electrode, the light emitting layer emits light and the amount of light emitted varies with the amount (or magnitude) of current so that light having a brightness corresponding to the amount of current is displayed (or emitted).

FIG. 1 is a circuit diagram illustrating a pixel that may be used in an organic light emitting display. Referring to FIG. 1, the pixel includes a first transistor T1, a second transistor T2, a capacitor Cst, and an OLED. Each of the first transistor T1 and the second transistor T2 includes a source, a gate, and a drain. In addition, the capacitor Cst includes a first electrode and a second electrode.

Referring to the first transistor T1, the source is coupled to a first pixel power source ELVDD, the drain is coupled to the OLED, and the gate is coupled to a first node A.

Referring to the second transistor T2, the source is coupled to a data line Dm, the drain is coupled to the first node A, and the gate is coupled to a scan line Sn.

Referring to the capacitor, the first electrode is coupled to the first pixel power source and the second electrode is coupled to the first node A.

Referring to the OLED, an organic light emitting layer is formed between an anode and a cathode. The OLED emits light in accordance with (or to correspond to) the amount of current that flows from the anode to the cathode. The anode is coupled to the drain of the first transistor T1 and the cathode is coupled to a second pixel power source ELVSS.

Referring to a pixel having the above structure, current corresponding to the following EQUATION 1 flows to the OLED.

### [EQUATION 1]

$${I}_{OLED} = \frac{β}{2} {( Vgs - Vth )}^{2}$$

wherein, I_{OLED}, β, Vgs, and Vth represent the amount of current that flows to the OLED, a constant, a voltage between the source and gate of the first transistor, and the threshold voltage of the first transistor T1, respectively.

As illustrated in the above EQUATION 1, the current that flows to the OLED is affected by (or depends on) the threshold voltage of the first transistor. The threshold voltage of the first transistor T1 varies with each pixel due to variations due to the manufacturing process which cause the brightness of the pixels to be non-uniform.

### SUMMARY

Accordingly, embodiments of the present invention are directed to a pixel capable of compensating for variations in threshold voltages to reduce or prevent picture quality deterioration and an organic light emitting display using the same.

In order to achieve the foregoing and/or other aspects of the present invention, according to one embodiment of the present invention, a pixel includes an organic light emitting diode (OLED) configured to receive a pixel current that flows from a first pixel power source to a second pixel power source and to emit light, a first transistor having a first electrode coupled to a first node, a second electrode coupled to a second node, and a gate coupled to a third node, the first transistor being configured to control the pixel current that flows from the first electrode to the second electrode in accordance with a voltage of the third node, a second transistor configured to selectively supply a data signal and an initialization signal to the first node, a third transistor configured to selectively couple the second node to the third node, a fourth transistor having a second electrode and a gate coupled to the first node and a first electrode coupled to the third node, a fifth transistor configured to selectively transmit the first pixel power source to the first node, a sixth transistor configured to selectively transmit the pixel current to the OLED, and a first capacitor having a first electrode coupled to the first pixel power source and a second electrode coupled to the third node.

According to another embodiment of the present invention, an organic light emitting display includes a display unit including a plurality of pixels, a data driver configured to supply data signals and initialization signals to the plurality of pixels, and a scan driver configured to supply a plurality of scan signals to the plurality of pixels. The pixel includes an organic light emitting diode (OLED) configured to receive a pixel current that flows from a first pixel power source to a second pixel power source and to emit light, a first transistor having a first electrode coupled to a first node, a second electrode coupled to a second node, and a gate coupled to a third node, the first transistor being configured to control the pixel current that flows from the first electrode to the second electrode in accordance with the voltage of the third node, a second transistor configured to selectively supply a data signal and an initialization signal to the first node, a third transistor configured to selectively couple the second node to the third node, a fourth transistor having a second electrode and a gate coupled to the first node and a first electrode coupled to the third node, a fifth transistor configured to selectively transmit the first pixel power source to the first node, a sixth transistor configured to selectively transmit the pixel current to the OLED, and a first capacitor having a first electrode coupled to the first pixel power source and a second electrode coupled to the third node.

In pixels according to embodiments of the present invention and the organic light emitting displays using the same, it is possible to compensate for non-uniformity in threshold voltages so that it is possible to reduce or prevent brightness non-uniformity and to improve picture quality.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a circuit diagram illustrating a pixel which may be used in an organic light emitting display;

FIG. 2 is a block diagram illustrating an organic light emitting display according to one embodiment of the present invention;

FIG. 3 is a circuit diagram illustrating a pixel which may be used in the organic light emitting display of FIG. 2 according to a first embodiment of the present invention;

FIG. 4 is a timing diagram illustrating an operation of the pixel of FIG. 3; and

FIG. 5 is a circuit diagram illustrating a pixel which may be used in the organic light emitting display of FIG. 2 according to a second embodiment of the present invention.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to a complete understanding of the invention are omitted for clarity. Also, like reference numerals refer to like elements throughout.

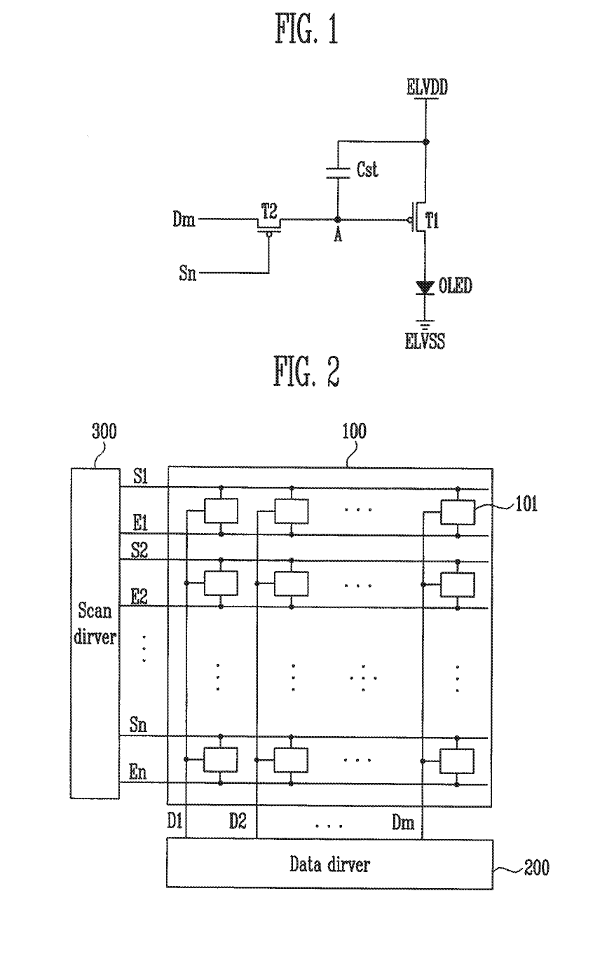

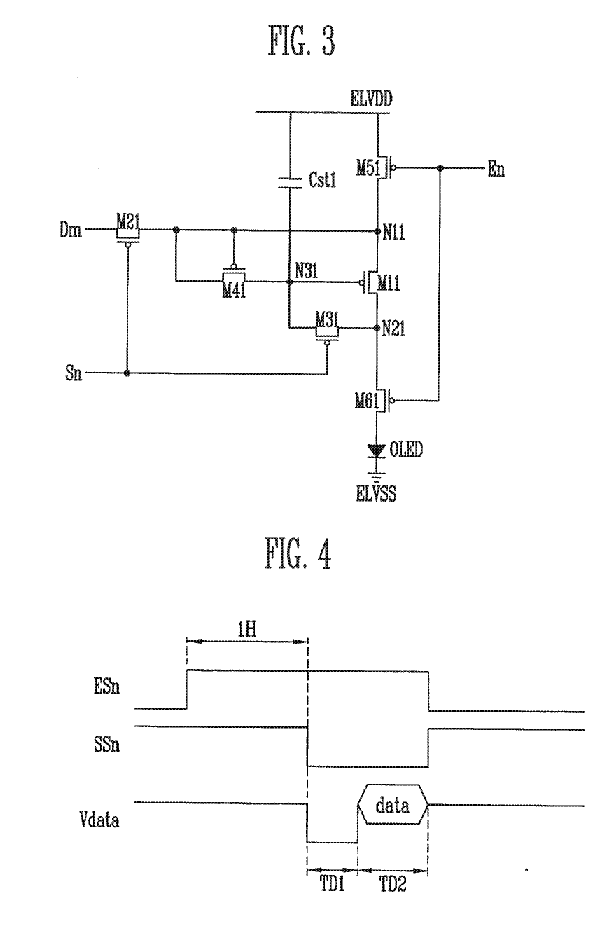

FIG. 2 is a block diagram illustrating an organic light emitting display according to a first embodiment of the present invention. Referring to FIG. 2, the organic light emitting display includes a display unit 100, a data driver 200, and a scan driver 300.

The display unit 100 includes m data lines D1, D2, . . . , Dm−1, and Dm, n scan lines S1, S2, . . . , Sn−1, and Sn, and n emission control lines E1, E2, . . . , En−1, and En and a plurality of pixels 101 formed in crossing regions of the m data lines D1, D2, . . . , Dm−1, and Dm, the n scan lines S1, S2, . . . , Sn−1, and Sn, and the n emission control lines E1, E2, . . . , En−1, and En. The pixels 101 include pixel circuits and organic light emitting diodes (OLEDs) and receive data signals transmitted from a data driver 200 through m data lines D1, D2, . . . , Dm−1, and Dm and scan signals and emission control signals that are provided to the pixels 101 through the n scan lines S1, S2, . . . , Sn−1, and Sn and n emission control lines E1, E2, . . . , En−1, and En, respectively. The data signals, scan signals, and emission control signals control the pixel currents that flow to the OLEDs. In addition, the pixels 101 receive a first pixel power source ELVDD and a second pixel power source ELVSS so that the pixel currents corresponding to the data signals may flow to the pixels.

The data driver 200 is coupled to the m data lines D1, D2, . . . , Dm−1, and Dm, generates the data signals, and sequentially transmits initialization signals and data signals through the m data lines D1, D2, . . . , Dm−1, and Dm to the rows of pixels of the display unit. The initialization signals are input to the m data lines D1, D2, . . . , Dm−1, and Dm before the data signals and initialize the voltages charged in the capacitors included in the pixels so that the data signals are transmitted to the m data lines D1, D2, . . . , Dm−1, and Dm and that the pixel currents corresponding to the data signals may be formed by the pixels 101.

The scan driver 300 is coupled to the n scan lines S1, S2, . . . , Sn−1, and Sn and generates and transmits the scan signals to the n scan lines S1, S2, . . . , Sn−1, and Sn.

In addition, the scan driver 300 is coupled to the n emission control lines E1, E2, . . . , En−1, and En and generates and transmits the emission control signals to the n emission control lines E1, E2, . . . , En−1, and En. In FIG. 2, the emission control signals are depicted as being generated by the scan driver 300. However, in other embodiments of the present invention, the emission control signals are generated by an additional driver (e.g., an emission control driver) and the emission control signals may be transmitted to the n emission control lines E1, E2, . . . , En−1, and En.

FIG. 3 is a circuit diagram illustrating a pixel which may be used in the organic light emitting display of FIG. 2 according to a first embodiment of the present invention. Referring to FIG. 3, a pixel 101 includes a first transistor M11, a second transistor M21, a third transistor M31, a fourth transistor M41, a fifth transistor M51, a sixth transistor M61, a first capacitor Cst1, and an organic light emitting diode OLED. Each of the transistors includes a source, a gate, and a drain. The source and the drain may be referred to as a first electrode and a second electrode. In addition, the first capacitor Cst1 includes a first electrode and a second electrode.

Referring to the first transistor M11, a source is coupled to a first node N11, a drain is coupled to a second node N21, and a gate is coupled to a third node N31. Current flows from the source to the drain in accordance with (or to correspond to) the voltage of the gate.

Referring to the second transistor M21, a source is coupled to the data line Dm, a drain is coupled to the first node N11, and a gate is coupled to the scan line Sn. Therefore, the second transistor M21 selectively allows the data signal to flow through the data line Dm and to be transmitted to the first node N11 in accordance with the scan signal transmitted through the scan line Sn.

Referring to the third transistor M31, the source is coupled to the second node N21, the drain is coupled to the third node N31, and the gate is coupled to the scan line Sn. Therefore, the third transistor M31 selectively couples the second node N21 and the third node N31 to each other in accordance with the scan signal transmitted through the scan line Sn. That is, when the third transistor M31 is turned on, the gate and drain of the first transistor M11 are electrically coupled to each other so that the first transistor M11 is diode-connected. Therefore, when the third transistor M31 is turned on, the source of the first transistor M11 coupled to the first node N11 may be considered as an anode electrode and the drain of the first transistor M11 coupled to the second node N21 may be considered as a cathode electrode when the first transistor M11 is diode-connected.

Referring to the fourth transistor M41, the source is coupled to the third node N31 and the drain and gate are coupled to the first node N11. That is, the fourth transistor M41 is diode-connected. The anode (or source) of the fourth transistor M41 is coupled to the third node N31 and the cathode (or drain) of the fourth transistor M41 is coupled to the first node N11.

Referring to the fifth transistor M51, the source is coupled to the first pixel power source ELVDD, the drain is coupled to the first node N11, and the gate is coupled to the emission control line En. Therefore, the fifth transistor M51 selectively supplies the voltage of the first pixel power source ELVDD to the first node N11 in accordance with the emission control signal transmitted through the emission control line En.

Referring to the sixth transistor M61, the source is coupled to the second node N21, the drain is coupled to the OLED, and the gate is coupled to the emission control line En. Therefore, the sixth transistor M61 selectively supplies the pixel current that flows from the source of the first transistor M11 to the drain of the first transistor M11 in accordance with the emission control signal transmitted through the emission control line so that the pixel current may be supplied to the OLED.

Referring to the first capacitor Cst1, the first electrode is coupled to the first pixel power source ELVDD and the second electrode is coupled to the third node N31. Therefore, the voltage of the third node N31 is maintained by the first capacitor Cst1.

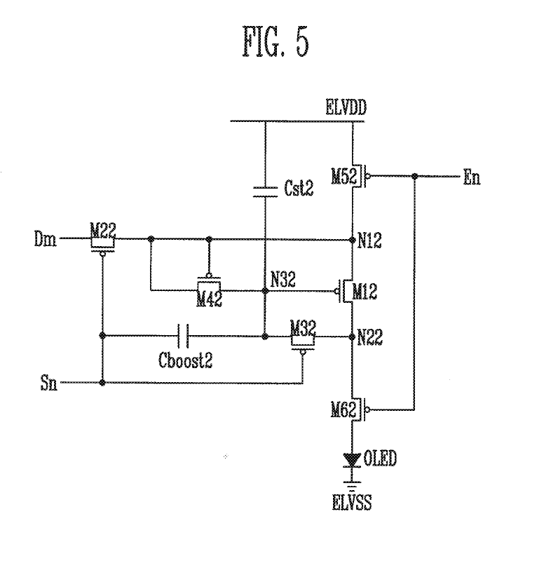

FIG. 4 is a timing diagram illustrating an operation of the pixel of FIG. 3 in accordance with one embodiment of the present invention. Referring to FIG. 4, signals input to the pixel 101 include a scan signal SSn, an emission control signal ESn, an initialization signal, and a data signal data. Here, the initialization signal is supplied through the data line Dm before the data signal data.

When the emission control signal ESn is in a high level, the fifth transistor M51 and the sixth transistor M61 are turned off so that the first pixel power source ELVDD is not supplied to the source of the first transistor M11 and that the pixel current is not generated. Then, the scan signal SSn is supplied in a low level.

When the scan signal SSn is supplied in a low level, the second transistor M21 and the third transistor M31 are turned on. When the second transistor M21 is turned on, the data signal that flows to the data line Dm is supplied to the first node N11. The data signal to be supplied through the data line is supplied during a first period TD1 and a second period TD2. During the first period TD1, an initialization signal for initializing the first node N11 is supplied. During the second period TD2, the data signal data corresponding to data for generating the pixel current is supplied.

In one embodiment of the present invention, during the first period TD1, the initialization signal transmitted to the first node N11 is a voltage having a low level. During the first period TD1, the voltage of the drain and gate of the fourth transistor M41 are at a low level. Therefore, the fourth transistor M41 is diode-connected, and current flows from the third node N31 through the fourth transistor M41 to the data line Dm. Therefore, the gate voltage of the first transistor M11 stored in the third node N31 is initialized to be in a low level by the initialization signal. In addition, during the first period TD1, the first transistor M11 is also diode-connected by the third transistor M31.

During the second period TD2, the data signal data is input (or supplied to the data line). During the second period TD2, the fourth transistor M41 is turned off and the data signal data is transmitted to the first node N11. During the second period TD2, the third transistor M31 is maintained in a diode-connected state. Therefore, the signal transmitted to the first node N11 is also transmitted to the third node N31. During the second period TD2, the threshold voltage of the first transistor M11 is compensated for.

Therefore, the voltage between the gate and source of the first transistor M11 is as illustrated in EQUATION 2.

Vgs=Vdata+Vth−ELVDD [EQUATION 2]

wherein, Vgs, Vdata, Vth, and ELVDD represent the voltage between the gate and source of the first transistor M11, the voltage of the signal corresponding to the data, the threshold voltage of the first transistor M11, and the voltage of the first pixel power source ELVDD, respectively.

Therefore, the current that flows to the OLED is as illustrated in EQUATION 3.

$${I}_{OLED} = \frac{β}{2} {( Vdata - ELVDD )}^{2} \qquad [ EQUATION 3 ]$$

wherein, I_{OLED}, β, Vdata, and ELVDD represent the current that flows to the OLED, a constant, the voltage of the data signal data, and the voltage of the first pixel power source ELVDD, respectively.

Therefore, the amount (or magnitude) of current that flows to the OLED does not depend on the threshold voltage of the first transistor M11.

In addition, the scan signal SSn, the data signal data, and the emission control signal ESn are supplied to the pixel 101 and only the first pixel power source ELVDD and the second pixel power source ELVSS are supplied to the pixel 101. Therefore, the structure of the pixel 101 is simple.

FIG. 5 is a circuit diagram illustrating a pixel which may be used in the organic light emitting display of FIG. 2 according to a second embodiment of the present invention. The pixel illustrated in FIG. 5 is different from the first embodiment pixel illustrated in FIG. 3 in that a second capacitor Cboost2 is further included. Referring to FIG. 5, the pixel includes a first transistor M12, a second transistor M22, a third transistor M32, a fourth transistor M42, a fifth transistor M52, a sixth transistor M62, a first capacitor Cst2, a second capacitor Cboost2, and an OLED.

Referring to the first transistor M12, a source is coupled to a first node N12, a drain is coupled to a second node N22, and a gate is coupled to a third node N32. The first transistor M12 controls the flow of current from the source to the drain in accordance with the voltage of the gate.

Referring to the second transistor M22, a source is coupled to the data line Dm, a drain is coupled to the first node N12, and a gate is coupled to the scan line Sn. Therefore, the second transistor M22 selectively allows the data signal to flow through the data line Dm and to be transmitted to the first node N12 in accordance with the scan signal transmitted through the scan line Sn.

Referring to the third transistor M32, a source is coupled to the second node N22, a drain is coupled to the third node N32 and a gate is coupled to the scan line Sn. Therefore, the third transistor M32 selectively couples the second node N22 to the third node N32 in accordance with the scan signal transmitted through the scan line Sn. That is, when the third transistor M32 is turned on, the gate of the first transistor M12 is electrically coupled to the drain of the first transistor M12 so that the first transistor M12 is diode-connected. Therefore, when the third transistor M32 is turned on, the source of the first transistor M12 coupled to the first node N12 may be considered as an anode and the drain of the first transistor M12 coupled to the second node N22 may be considered a cathode so that the first transistor M12 is in the form of a diode.

Referring to the fourth transistor M42, a source is coupled to the third node N32 and a drain and a gate are coupled to the first node N12. That is, the fourth transistor M42 is diode-connected. The anode (or source) of the fourth transistor M42 is coupled to the third node N32 and the cathode (or drain) of the fourth transistor M42 is coupled to the first node N12.

Referring to the fifth transistor M52, a source is coupled to the first pixel power source ELVDD, a drain is coupled to the first node N12, and a gate is coupled to the emission control line En. Therefore, the fifth transistor M52 selectively supplies the voltage of the first pixel power source ELVDD to the first node N12 in accordance with the emission control signal transmitted through the emission control line En.

Referring to the sixth transistor M62, a source is coupled to the second node N22, a drain is coupled to the OLED, and a gate is coupled to the emission control line En. Therefore, the sixth transistor M62 controls the supply of the pixel current that flows from the source of the first transistor M12 to the drain of the first transistor M12 in accordance with the emission control signal transmitted through the emission control line En so that the pixel current may be supplied to the OLED.

Referring to the first capacitor Cst2, a first electrode is coupled to the first pixel power source ELVDD and a second electrode is coupled to the third node N32. Therefore, the voltage of the third node N32 is maintained by the first capacitor Cst2.

Referring to the second capacitor Cboost2, a first electrode is coupled to the scan line Sn and a second electrode is coupled to the third node N32. Therefore, the voltage of the third node N32 changes in accordance with a change in the scan signal transmitted through the scan line Sn. That is, when the scan signal transitions from a low level to a high level, the voltage of the third node N32 increases by the second capacitor Cboost2. Therefore, the voltage applied to the gate of the first transistor M12 increases. Therefore, although the voltage of the data signal is not increased, the voltage applied to the gate of the first transistor M12 may be set to be high so that the output of a data driver for outputting the data signal may be set to be low.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel comprising:
an organic light emitting diode (OLED) configured to receive a pixel current that flows from a first pixel power source to a second pixel power source and to emit light;
a first transistor having a first electrode coupled to a first node, a second electrode coupled to a second node, and a gate coupled to a third node, the first transistor being configured to control the pixel current that flows from the first electrode to the second electrode in accordance with a voltage of the third node;
a second transistor for selectively supplying a data signal and an initialization signal to the first node;
a third transistor for selectively coupling the second node to the third node;
a fourth transistor having a second electrode and a gate coupled to the first node and a first electrode coupled to the third node;
a fifth transistor for selectively transmitting a voltage of the first pixel power source to the first node;
a sixth transistor for selectively transmitting the pixel current to the OLED; and
a first capacitor having a first electrode coupled to the first pixel power source and a second electrode coupled to the third node.

2. The pixel as claimed in claim 1, further comprising a second capacitor having a first electrode coupled to the third node and a second electrode coupled to a scan line, the scan line being coupled to a gate electrode of the second transistor.

3. The pixel as claimed in claim 1, wherein the data signal is supplied after the initialization signal is supplied.

4. The pixel as claimed in claim 1, wherein the initialization signal is a voltage having a low level.

5. The pixel as claimed in claim 1,
wherein the second transistor and the third transistor are configured to be turned on/off by a scan signal, and
wherein the fifth transistor and the sixth transistor are configured to be turned on/off by an emission control signal.

6. The pixel as claimed in claim 5, wherein, the second transistor and the third transistor are configured to be turned on when the fifth transistor and the sixth transistor are turned off.

7. An organic light emitting display comprising:
a display unit comprising a plurality of pixels;
a data driver for supplying a plurality of data signals and a plurality of initialization signals to the plurality of pixels; and
a scan driver for supplying a plurality of scan signals to the plurality of pixels,
wherein a pixel of the plurality of pixels comprises:
an organic light emitting diode (OLED) configured to receive a pixel current that flows from a first pixel power source to a second pixel power source and to emit light;
a first transistor having a first electrode coupled to a first node, a second electrode coupled to a second node, and a gate coupled to a third node, the first transistor being configured to control the pixel current that flows from the first electrode to the second electrode in accordance with a voltage of the third node;
a second transistor for selectively supplying a data signal and an initialization signal to the first node;
a third transistor for selectively coupling the second node to the third node;
a fourth transistor having a second electrode and a gate coupled to the first node and a first electrode coupled to the third node;
a fifth transistor for selectively transmitting a voltage of the first pixel power source to the first node;
a sixth transistor for selectively transmitting the pixel current to the OLED; and
a first capacitor having a first electrode coupled to the first pixel power source and a second electrode coupled to the third node.

8. The organic light emitting display as claimed in claim 7, the pixel further comprising a second capacitor having a first electrode coupled to the third node and a second electrode coupled to a scan line, the scan line being coupled to a gate electrode of the second transistor.

9. The organic light emitting display as claimed in claim 7, wherein the data driver is configured to supply a data signal of the plurality of data signals after an initialization signal of the plurality of initialization signals is supplied.

10. The organic light emitting display as claimed in claim 7, wherein the data driver is configured to supply the initialization signal as a voltage having a low level.

11. The organic light emitting display as claimed in claim 7,
wherein the second transistor and the third transistor are configured to be turned on/off by a scan signal, and
wherein the fifth transistor and the sixth transistor are configured to be turned on/off by an emission control signal.

12. The organic light emitting display as claimed in claim 11, wherein the scan driver is configured to turn on the second transistor and the third transistor when the fifth transistor and the sixth transistor are turned off.
